(19) United States
(12) Patent Application Publication
(10) Pub. No.: US 2002/0002551 A1
(43) Pub. Date: Jan. 3, 2002

(54) System, methods and computer program products that facilitate selection of equipment for performing tasks

(76) Inventor: William H. Dears, Cary, NC (US)

Correspondence Address: MYERS BIGEL SIBLEY & SAJOVEC, PO BOX 37428, RALEIGH, NC, 27627, US

(21) Appl. No.: 09/827,288

(22) Filed: Apr. 5, 2001

Related U.S. Application Data
(60) Provisional application No. 60/194,465, filed on Apr. 4, 2000.

(51) Int. Cl. G06F 7/00

(52) U.S. Cl. 707/3

(57) ABSTRACT

Embodiments of systems, methods, and computer program products are provided for selecting devices for performing a task. A description of a task is received from a user and is used to generate a list of devices for performing the task. The generated list of devices may need refinement, however, depending on the information contained in the task description. A determination is made whether additional information is needed to refine the generated list. If additional information is needed, then the user is queried for additional information to refine the generated list of devices.

### CROSS-REFERENCE TO PROVISIONAL APPLICATION

This application claims the benefit of Provisional Application Serial No. 60/194,465, filed Apr. 5, 2000, entitled Systems, Methods and Computer Program Products That Facilitate Selection of Equipment for Performing Tasks, the disclosure of which is hereby incorporated herein by reference in its entirety as if set forth fully herein.

### BACKGROUND OF THE INVENTION

The present invention relates generally to the field of electronic commerce and, more particularly, to interactive user interface systems for selecting items.

Construction projects typically comprise many different types of tasks or projects. Each of these tasks or projects may require a particular set of tools, equipment, devices, machines, etc. Typically, the task to be performed defines the equipment, devices, etc. that are needed to perform the task. Unfortunately, a contractor may not be aware of the particular pieces of equipment that may be needed to perform a task.

Moreover, the construction industry has many original equipment manufacturers and alternative equipment manufacturers. Design and manufacturing standards generally drive compatibility of parts such as bolts, nuts, and fittings; however, equipment manufactured by different manufacturers, although functionally similar, may not share a common interface. Manufacturers may provide lists that identify products from other manufacturers that are compatible with their product lines. Nevertheless, manufacturers may not be aware of many products in the marketplace that may be compatible with their product line. Accordingly, a contractor may need to perform extensive research to verify that various pieces of equipment are compatible with each other to ensure that they will work properly once on the job site.

### SUMMARY OF THE INVENTION

Embodiments of the present invention provide systems, methods, and computer program products for selecting devices for performing a task. A description of a task is received from a user and is used to generate a list of devices for performing the task. The generated list of devices may need refinement, however, depending on the information contained in the task description. A determination is made whether additional information is needed to refine the generated list. If additional information is needed, then the user is queried for additional information to refine the generated list of devices.

Advantageously, the present invention may provide a user with a device and/or equipment solution for a particular task or application. Moreover, the user need not know the details of particular devices that may be used to accomplish the task. Instead, the user may describe a particular task to be accomplished and, if this description is insufficient by itself to generate a list of devices to perform the task, then the user will be prompted to provide additional information so that a refined list of devices may be generated that can be used to provide a solution for performing the task.

Additional information may be obtained from the user by presenting the user with one or more questions and then receiving answers to those questions from the user. In particular embodiments of the present invention, the user may be presented with one or more questions relating to a performance criterion for performing the task. The performance criterion may relate to the speed in which the task needs to be performed, which drives a minimum and/or maximum power requirement for the device(s), a size requirement for the device(s), etc.

In accordance with further embodiments of the present invention, the generated list of devices comprises one or more device combinations. The devices comprising these device combinations may be verified to be compatible with one another. Frequently, a task may involve devices from several different manufacturers. Unfortunately, devices from different manufacturers that perform similar functions may not share a common interface and, therefore, may not be interchangeable when compiling a set of devices to perform a specific task. Advantageously, the present invention may allow the compatibility of devices to be verified electronically without the need for the user to contact different manufacturers to confirm whether particular devices are compatible with one another.

In accordance with particular embodiments of the present invention, the criteria used to evaluate device compatibility may comprise geometric compatibility, hydraulic compatibility, and capacity compatibility. Devices comprising a device combination may be assigned a degree of compatibility with one another. This aspect of the present invention may be particularly useful when devices are not 100% compatible with each other.

In accordance with further embodiments of the present invention, the devices comprising the generated list of devices may be ranked based on their suitability for performing the task.

In accordance with still further embodiments of the present invention, the list of devices for performing a task may be generated by forming a database query based on the task description and searching one or more databases using the database query. Exemplary databases that may be used in embodiments of the present invention include, but are not limited to, an online product database, a rental equipment database, an auction equipment database, and a user equipment database.

In accordance with further embodiments of the present invention, a user may select one or more of the devices from the list of device(s) generated for performing the task. A device may be viewed as an attachment device, a dedicated device, or a host device. An attachment device is typically not used individually, but instead is attached to a host device to perform its function.

If the selected device is a dedicated device, then the user may be presented with an option of acquiring the selected device. If the user responds with an indication that the user desires to acquire the selected device, then the selected device is acquired for the user.

In accordance with further embodiments of the present invention, if the device selected by the user is an attachment device, then the user may be presented with an option to search for one or more host devices that are compatible with the selected device. Conversely, if the device selected by the user is a host device, then the user may be presented with an option to search for one or more attachment devices that are compatible with the selected device. If the user responds with an indication that the user does not desire to search for compatible devices, then the user may be presented with an option of acquiring the selected device. If the user responds with an indication that the user desires to acquire the selected device, then the selected device is acquired for the user.

If, however, the user responds with an indication that the user desires to search for compatible devices, then a list is generated that comprises one or more devices that are compatible with the selected device. In accordance with particular embodiments of the present invention, the list of one or more devices that are compatible with the selected device may be generated by forming a database query based on the selected device and searching one or more databases using the database query. Exemplary databases that may be used in embodiments of the present invention include, but are not limited to, an online product database, a rental equipment database, an auction equipment database, and a user equipment database.

In accordance with still further embodiments of the present invention, the user may be presented with an option of acquiring the selected device and a host device from the list of one or more host devices or, alternatively, an option of acquiring the selected device and an attachment device from the list of one or more attachment devices. If the user responds with an indication that the user desires to acquire the selected device and the host or attachment device from the list of one or more host or attachment devices, then both the selected device and the host or attachment device from the list of one or more host or attachment devices are acquired for the user.

### BRIEF DESCRIPTION OF THE DRAWINGS

FIG. 1 is a schematic that illustrates exemplary systems, methods, and computer program products for selecting devices to perform a task in accordance with embodiments of the present invention;

FIGS. 2A-2C are a flowchart that illustrates exemplary operations for selecting devices to perform a task in accordance with embodiments of the present invention; and

FIGS. 3 and 4 are block diagrams that illustrate exemplary operations of schema translators in accordance with embodiments of the present invention.

### DETAILED DESCRIPTION OF THE INVENTION

The present invention is described hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout the description of the drawings.

The Internet is a worldwide decentralized network of computers having the ability to communicate with each other. The Internet has gained broad recognition as a viable medium for communicating and for conducting business. The World-Wide Web (Web) is comprised of server-hosting computers (Web servers) connected to the Internet that have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device, and/or between wireless client/devices and Wireless Application Protocol (WAP) server devices. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), Wireless Markup Language (WML), as well as image formats such as Graphics Interchange Format (GIF) and Joint Photographic Experts Group (JPEG).

A Web site is conventionally a related collection of Web files that includes a beginning file called a “home” page. From the home page, a visitor can access other files and applications at a Web site. A large Web site may utilize a number of servers, which may or may not be different and which may or may not be geographically-dispersed. For example, the Web site of the International Business Machines Corporation (www.ibm.com) consists of thousands of Web pages and files spread out over multiple Web servers in locations world-wide.

A Web server (also referred to as an HTTP server) is a computer program that utilizes HTTP to serve files that form Web pages to requesting Web clients. Exemplary Web servers include International Business Machines Corporation's family of Lotus Domino® servers, the Apache server (available from www.apache.org), and Microsoft's Internet Information Server (IIS), available from Microsoft Corporation, Redmond, Washington. A Web client is a requesting program that also utilizes HTTP. A browser is an exemplary Web client for use in requesting Web pages and files from Web servers. A Web server waits for a Web client, such as a browser, to open a connection and to request a specific Web page or application. The Web server then sends a copy of the requested item to the Web client, closes the connection with the Web client, and waits for the next connection.

HTTP allows a browser to request a specific item, which a Web server then returns and the browser renders within a display screen. To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized by users accessing a Web site according to the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects (i.e., activates) a particular hypertext link, a browser running on the user's client device reads and interprets an address, called a Uniform Resource Locator (URL) associated with the hypertext link, connects the browser with a Web server at that address, and makes a request (e.g., an HTTP request) for the file identified in the hypertext link. The Web server then sends the requested file to the client device, which the browser interprets and renders within a display screen.

As will be appreciated by one of skill in the art, the present invention may be embodied as methods, data processing systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C.” In addition, Microsoft Active Server Pages (ASP) technology, Java Server Pages (JSP) technology, Wireless Markup Language (WML), and Allaire Cold Fusion Markup Language (CFML) technology may be utilized. It will be understood, however, that embodiments of the present invention are not limited to a particular software implementation. Portions of the program code may execute entirely on one or more data processing systems utilized by a Web site.

The present invention is described below with reference to block diagram and/or flowchart illustrations of methods, apparatus (systems) and computer program products according to an embodiment of the invention. It is understood that each block of the block diagram and/or flowchart illustrations, and combinations of blocks in the block diagram and/or flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagram and/or flowchart block or blocks.

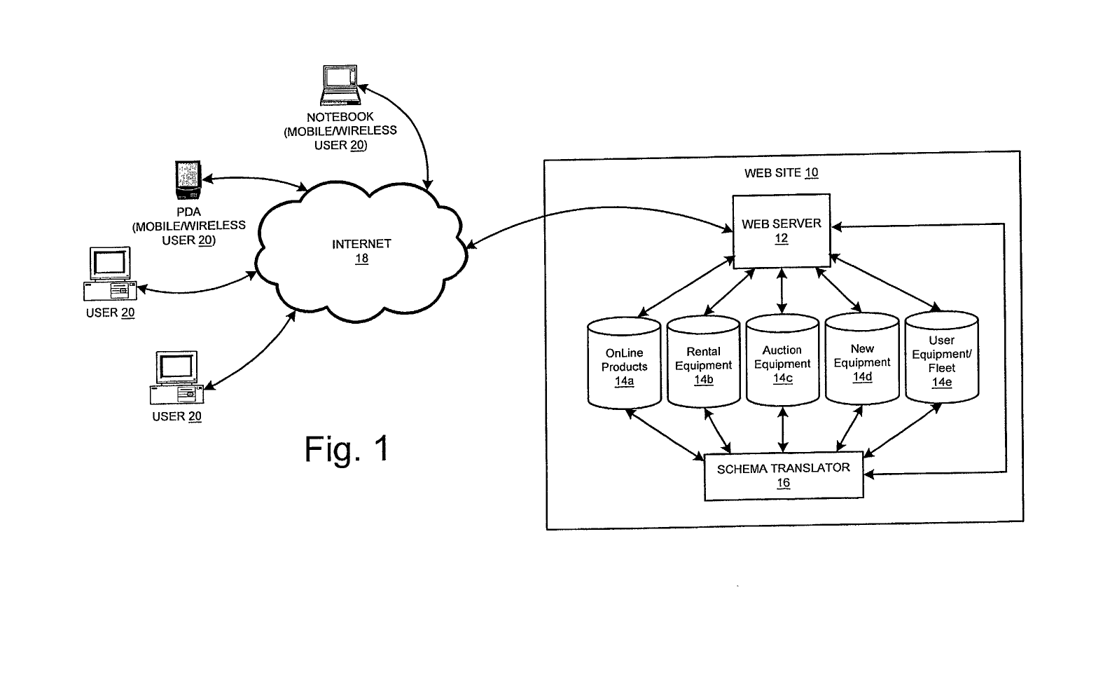

Referring now to FIG. 1, a Web site 10 that allows users to select a combination of equipment and work tool attachments for a particular task is schematically illustrated. The illustrated Web site 10 includes a Web server 12, multiple databases 14a-14e, and a schema translator 16. The schema translator 16 is responsible for accepting user interview data/parameters and feedback from the various databases 14a-14e. The schema translator 16 generates a unique database search object using query and interview data obtained from a user. Although a single Web server 12 is illustrated, it is understood that multiple Web servers (and other servers) may be utilized to perform the various functions of the Web site 10.

The Web server 12 is the “front end” component of the Web site 10 and is configured to handle various client requests from users 20 accessing the Web site 10 via a communications network, such as the Internet 18. Exemplary commercial Web servers that may be utilized as a Web server 12 in the illustrated system 10 are Apache, available from the Apache Server Project, http://www.apache.org; Microsoft's Internet Information Server (IIS), available from Microsoft Corporation, Redmond, Washington; and Netscape's FastTrack® and Enterprise™ servers, available from America Online, Inc., Dulles, Va. Other Web servers that may be utilized include Novell's Web Server for users of its NetWare® operating system, available from Novell, Inc., San Jose, Calif.; and IBM's family of Lotus Domino® servers, available from International Business Machines Corporation, Armonk, N.Y.

As is known by those of skill in the art, a database is a collection of data that is organized in “tables.” A database typically includes a database manager that facilitates accessing, managing, and updating data within the various tables of a database. Exemplary types of databases that can be utilized to perform the various functions of the illustrated databases 14a-14e, according to the present invention, include relational databases, distributed databases (databases that are dispersed or replicated among different points in a network), and object-oriented databases. Relational, distributed, and object-oriented databases are well understood by those of skill in the art and need not be discussed further herein. Exemplary databases that can be utilized to perform the various functions of the illustrated databases 14a-14einclude, but are not limited to, IBM's DB2® database, Microsoft's SQL server database, and database products from Oracle, Sybase, and Computer Associates.

The illustrated databases 14a-14einclude: an online product database 14a that contains online product parameters; a rental equipment database 14b that contains rental equipment product parameters; an auction equipment database 14c that contains auction product/equipment parameters; a new equipment database 14d that contains new equipment/product parameters; and a user equipment/fleet database 14e that contains user equipment/fleet parameters. The illustrated databases may include, but are not limited to, the exemplary parameters listed in Table 1 below.

TABLE 1

| Database | Parameters |
|---|---|
| Online | Name, Model, Manufacturer SKU, |
| Product | Manufacturer, Web SKU, Description, |
| | Specifications, Features, Options, Actual |
| | Weight, Shipping Weight, Stock Location, |
| | Price, Shipping Cost, Alternate Shipping |
| | Methods, etc. |
| Rental | Name, Model, Manufacturer, Description, |
| Equipment | Specifications, Features, Options, Actual |
| | Weight, Shipping Weight, Rental Locations, |
| | Rental Location Zip Code, Rental Rates, |
| | Shipping Cost, Pick Up Cost, Alternate |
| | Shipping Methods, etc. |
| Auction | Name, Model, Manufacturer SKU, |
| Equipment | Manufacturer, Web SKU, Description, |
| | Machine Hours, Condition, Specifications, |
| | Features, Options, Actual Weight, Shipping |
| | Weight, Stock Location, Location Zip Code, |
| | Price, Shipping Cost, Alternate Shipping |
| | Methods, etc. |
| New | Name, Model, Manufacturer, Description, |
| Equipment | Specifications, Features, Options, Actual |
| | Weight, Shipping Weight, Stock Locations, |
| | Dealer Locations, Location Zip Code, |
| | Price, Shipping Cost, Pick Up Cost, |
| | Alternate Shipping Methods, etc. |
| User | Name, Model, Manufacturer, Description, |
| Equipment | Machine Hours, Work Tool Hours, Condition, |
| | Specifications, Features, Options, Actual |
| | Weight, Shipping Weights, Storage |
| | Location, Location Zip Code, Price, |
| | Shipping Cost, Alternate Shipping Methods, |
| | Fleet Management Parameters, etc. |

An engine for a particular model of equipment may include, but is not limited to, the exemplary specification parameters listed in Table 2 below.

TABLE 2

| | Specification |
|---|---|
| Equipment | Parameters |
| Engine | Make |
| | Model |
| | Criteria |
| | Fuel Type |
| | Fuel Injection |
| | Cooling |
| | Cylinders |
| | Net Power |
| | Gross Power |
| | Displacement |
| | Aspiration |
| | Bore |
| | Stroke |
| | Peak Torque |
| | Peak Torque Speed |
| | Torque Rise |
| | High Idle |
| | Rated Speed |
| | Low Idle |

It is understood that various databases may be utilized with the present invention. The present invention is not limited to the illustrated databases.

A database server (not illustrated) may be utilized to serve as a “middleman” server between the Web server 12 and the various databases 14a-14e. As is known to those of skill in the art, a database server includes program code and logic for retrieving data from databases (and from sources external to a Web site) in response to requests from a Web server.

Exemplary commercial database servers that may be utilized as a database server in the illustrated system include Microsoft's SQL server, IBM DB2® Universal Database server, and the WebSphere™ Net.Commerce server, the latter two being available from International Business Machines Corporation, Armonk, N.Y.

The illustrated Web site 10 is configured to communicate with users 20 accessing the Web site 10 via a client program, such as a browser, running on a client device, such as a personal computer. However, it is understood that electronic devices, such as personal digital assistants (PDAs), hand-held computers, Internet-ready phones, WebTVs, and wireless devices (e.g., WAP devices) may be utilized as client devices for accessing the Web site 10 in accordance with the present invention.

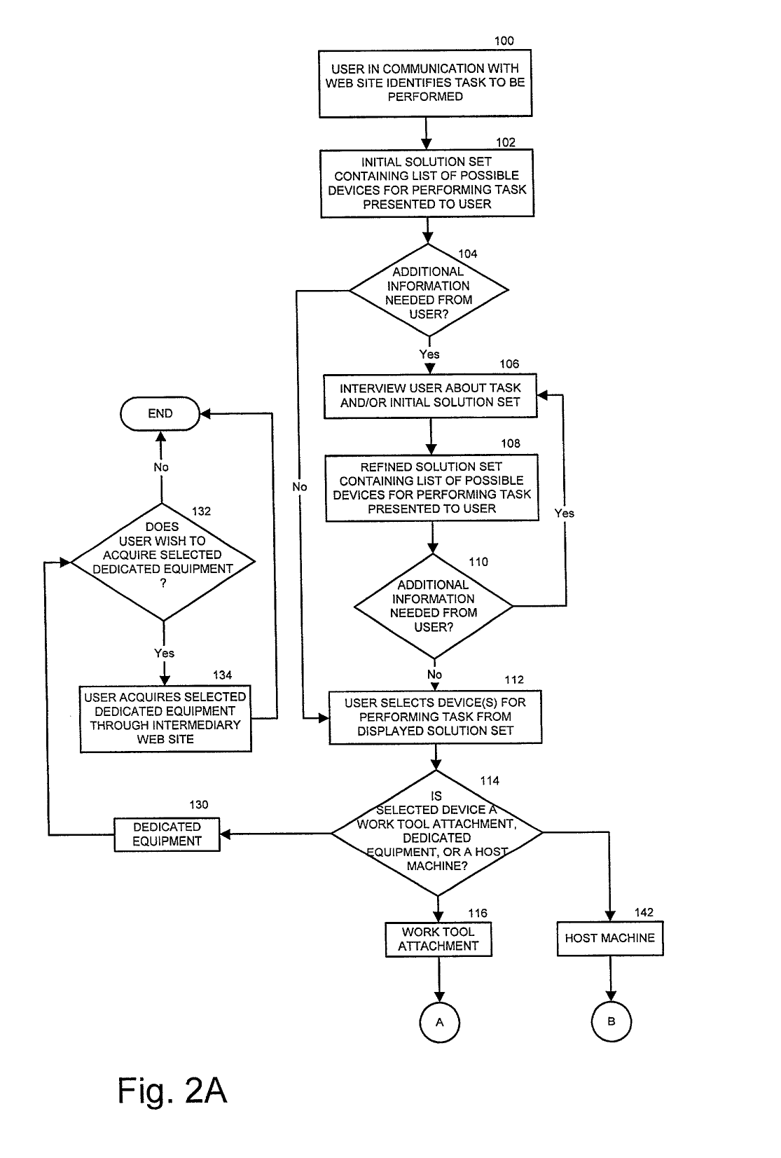

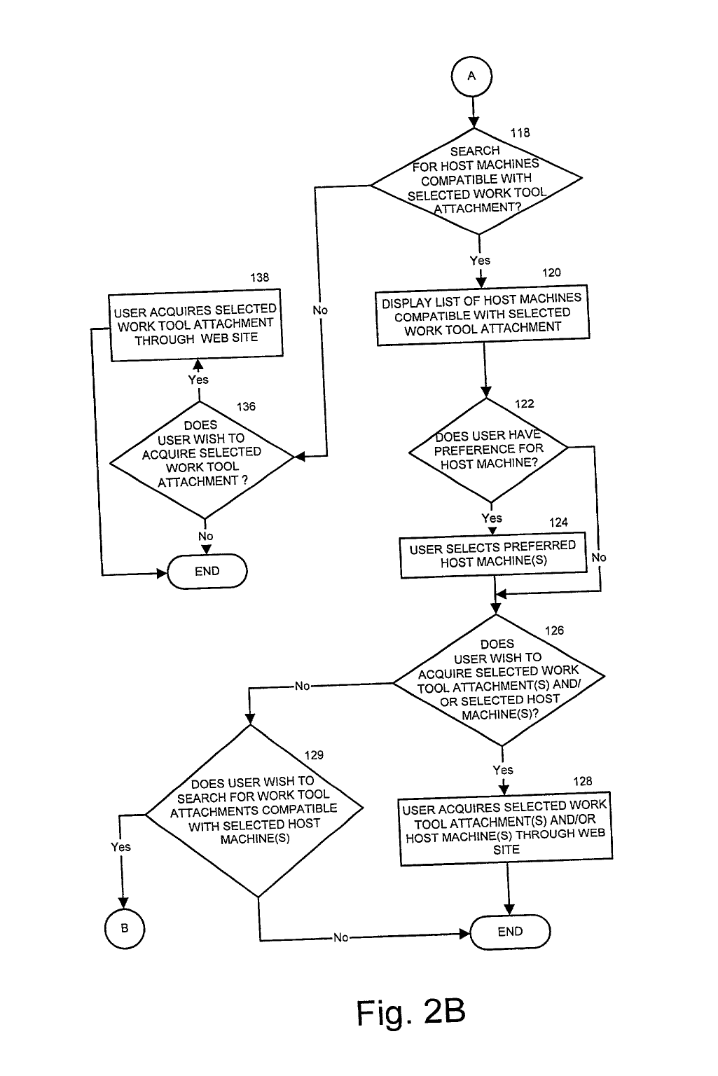

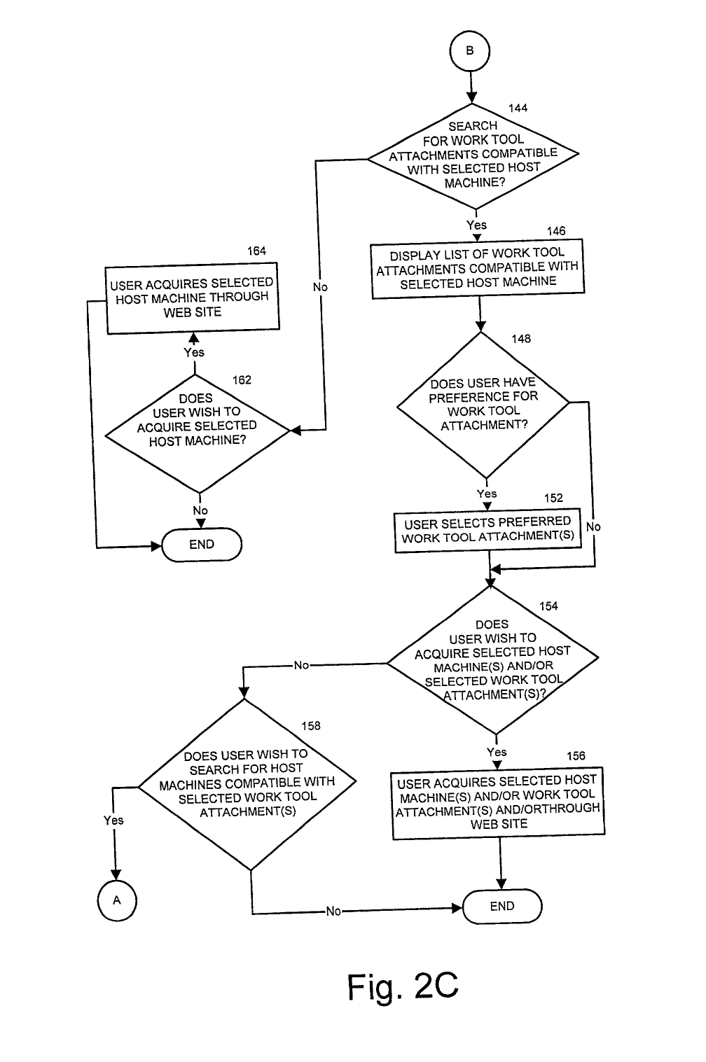

Referring now to FIGS. 2A-2C, operations for selecting work tools and equipment for performing a task, according to embodiments of the present invention, are illustrated. A user in communication with a Web site identifies a task to be performed (Block 100). In response to receiving a description of the identified task, the Web site produces an initial solution set that contains a list of possible devices for performing the identified task (Block 102). The term “devices” includes, but is not limited to, work tool attachments that can be used for multiple tasks, dedicated equipment that typically are used for specific tasks, and host machines that typically are used to host one or more work tool attachments (i.e., the work tool attachment(s) may be attached to the host machine). In accordance with embodiments of the present invention, the list of devices may also include a list of device combinations (e.g., a host machine and one or more work tool attachments) for performing the identified task. The Web site also makes a determination whether additional information is needed from the user in order to refine the solution set (Block 104).

If the answer at Block 104 is “Yes”, the Web site conducts an “interview” with the user to solicit additional information from the user (Block 106). The interview may include a list of questions presented to the user that the user answers and submits to the Web site. As would be understood by one of skill in the art, such an interview may be conducted via HTML forms that are served to the user's client, displayed to the user, “filled-out” by the user, and returned to the Web site. User interviews, however, may be conducted in various ways and are not limited to the use of HTML forms.

Certain specifications are associated with the ability to complete a task. Specifications are selected to adequately describe or match the requirements of the task. Accordingly, an interview conducted in accordance with the present invention may involve matching the scope of a task with an appropriate level of corresponding specifications. Specifications may be “performance-related” in that a user needs to perform a task in a certain quantifiable way. For example, a user may need to remove rocks by a certain amount over given intervals of time. Because one or more equipment databases utilized by the Web site preferably include specifications described at a machine model level and work tool model level, a direct relationship can be made between a task and a “best solution” of host machine(s) and/or work tools(s).

Upon completion of the interview, the Web site produces a refined solution set that contains a list of possible devices and/or device combinations for performing the identified task (Block 108). The Web site makes a determination whether additional information is still needed from the user in order to refine the solution set further (Block 110). If the answer at Block 110 is “Yes”, the Web site conducts another “interview” with the user to solicit additional information from the user (Block 106). Operations represented by Blocks 106-110 are repeated until it is determined that no further refinements can be made to the proposed solution set. The devices and/or device combinations comprising the proposed solution set may be ranked based on their suitability for performing the task in accordance with the present invention.

In each proposed solution set generated in accordance with the present invention, host machines and work tools are checked for compatibility with each other to ensure non-destructive and/or enhanced use. For example, the following categories of compatibility are within the scope of the present invention: geometry (i.e., the physical ability for host machines and work tools to be connected without static or dynamic interference); hydraulic (i.e., will the hydraulic system support or cause longevity issues? will there be too much/too little flow/pressure provided to work tool?); and capacities (i.e., can a host machine handle more or less force than a work tool?).

A degree of compatibility may be assigned between devices based on a particular compatibility criterion. This may indicate to the user that a particular host machine and work tool may not be compatible in one aspect (e.g., capacity), but may be compatible in another aspect (e.g., geometry).

Once the proposed solution set is final (i.e., no further refinements can be made) the user selects one or more devices and/or device combinations from the solution set (Block 112). A determination is then made whether the selected device is a work tool attachment, dedicated equipment, or a host machine (Block 114). For example, a determination is made whether the user has selected a particular back-hoe bucket (a work tool attachment), or whether the user has selected a trencher (a dedicated piece of equipment) for the task “digging,” or a back-hoe (host machine) to which, for example, the back-hoe bucket may be attached. If the selected device is a work tool attachment(s) (Block 116), then operations continue by following connector A to FIG. 2B where the user is then asked whether a search should be conducted for host machines that are compatible with the selected work tool attachment (Block 118). If the answer at Block 118 is “Yes”, a list of host machines compatible with the selected work tool attachment(s) is displayed to the user (Block 120).

The user is then asked whether he/she has any host machine preference(s) (Block 122). If the answer at Block 122 is “Yes”, the user selects or identifies one or more preferred host machines (Block 124). If the answer at Block 122 is “No”, or after the user selects or identifies one or more preferred host machines (Block 124), a determination is made whether the user wishes to acquire the selected work tool attachment(s) and/or selected host machine(s) (Block 126). If the answer at Block 126 is “Yes”, the user proceeds with acquiring (i.e., purchasing and/or leasing) the selected work tool attachment(s) and/or selected host machine(s) via the Web site (Block 128). If the answer at Block 126 is “No”, the user is asked whether he/she wishes to search for other work tool attachments that are compatible with the host machine(s) selected at Block 124 (Block 129). If the answer at Block 129 is “Yes,” then operations continue by following connector B to FIG. 2C where a search for work tool attachments is performed. If the answer at Block 129 is “No” or after the user acquires the selected work tool attachments) and/or host machine(s), operations terminate.

Returning to Block 118, if the user does not want to search for compatible host machines, a determination is made whether the user wishes to acquire the selected work tool attachment(s) (Block 136). If the answer at Block 136 is “Yes”, the user proceeds with acquiring (i.e., purchasing and/or leasing) the selected work tool attachment(s) via the Web site (Block 138). If the answer at Block 136 is “No”, operations terminate.

Returning to Block 114, if the selected device is dedicated equipment (Block 130), a determination is made whether the user wishes to acquire the selected dedicated equipment (Block 132). If the answer at Block 132 is “Yes”, the user proceeds with acquiring (i.e., purchasing and/or leasing) the selected dedicated equipment via the Web site (Block 134). If the answer at Block 132 is “No”, operations terminate.

Returning to Block 114, if the selected device is a host machine (Block 142), then operations continue by following connector B to FIG. 2C where the user is then asked whether a search should be conducted for work tool attachments that are compatible with the selected host machine (Block 144). If the answer at Block 144 is “Yes”, a list of work tool attachments compatible with the selected host machine(s) is displayed to the user (Block 146).

The user is then asked whether he/she has any work tool attachment preference(s) (Block 148). If the answer at Block 148 is “Yes”, the user selects or identifies one or more preferred work tool attachments (Block 152). If the answer at Block 148 is “No”, or after the user selects or identifies one or more preferred work tool attachments (Block 152), a determination is made whether the user wishes to acquire the selected host machine(s) and/or selected work tool attachment(s) (Block 154). If the answer at Block 154 is “Yes”, the user proceeds with acquiring (i.e., purchasing and/or leasing) the selected host machine(s) and/or selected work tool attachment(s) via the Web site (Block 156). If the answer at Block 154 is “No”, the user is asked whether he/she wishes to search for other host machines that are compatible with the work tool attachments selected at Block 152 (Block 158). If the answer at Block 158 is “Yes,” then operations continue by following connector A to FIG. 2B where a search for host machines is performed. If the answer at Block 158 is “No” or after the user acquires the selected host machine(s) and/or work tool attachment(s), operations terminate.

Returning to Block 144, if the user does not want to search for compatible work tool attachments, a determination is made whether the user wishes to acquire the selected host machine(s) (Block 162). If the answer at Block 162 is “Yes”, the user proceeds with acquiring (i.e., purchasing and/or leasing) the selected host machine(s) via the Web site (Block 164). If the answer at Block 162 is “No”, operations terminate.

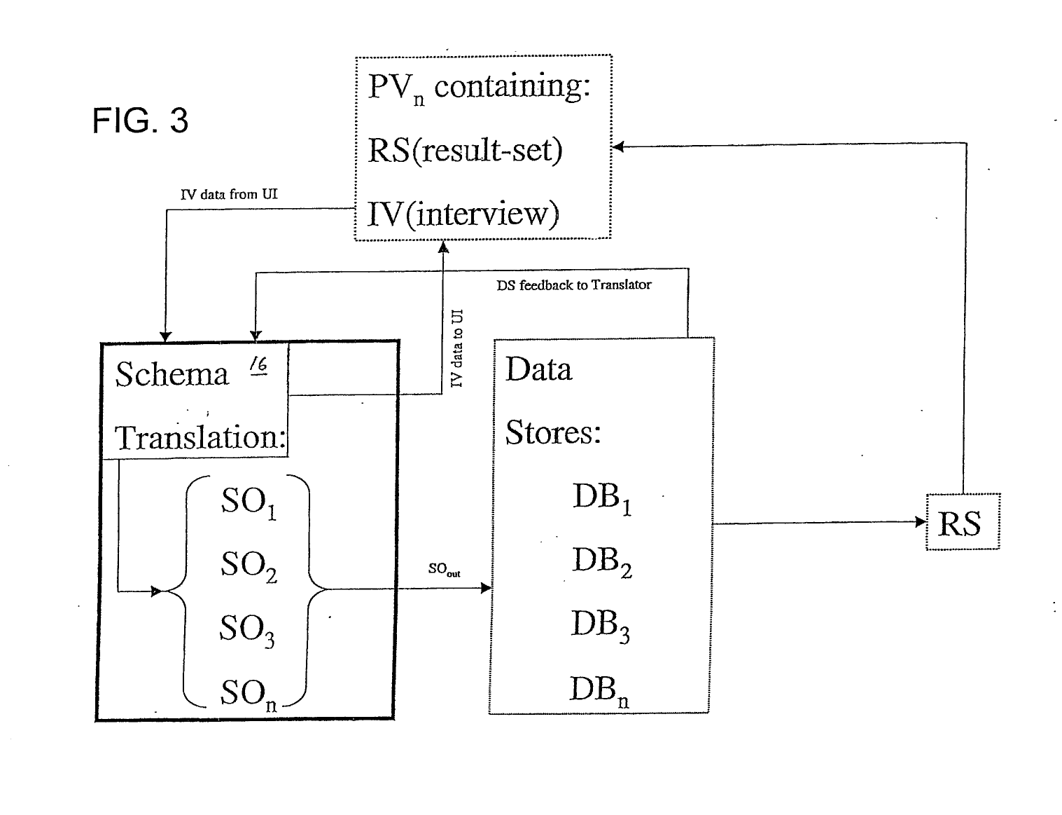

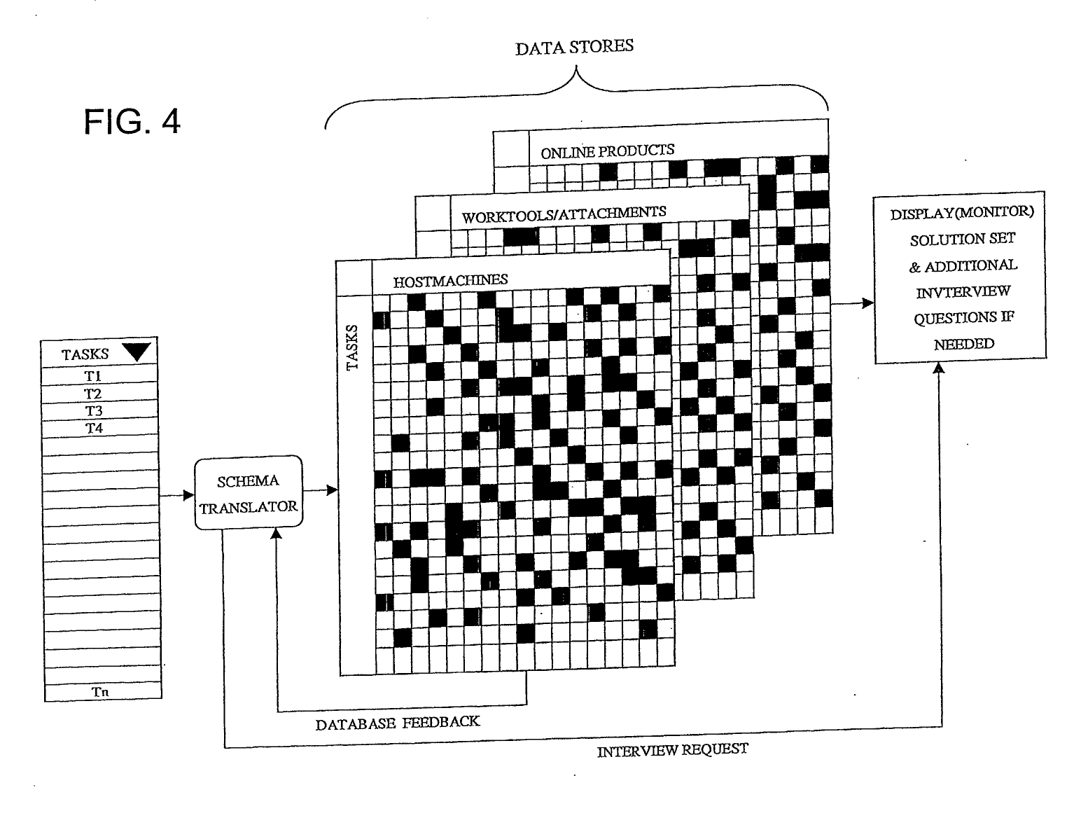

Referring now to FIGS. 3 and 4, operations performed by the schema translator 16 (FIG. 1) according to embodiments of the present invention are illustrated. The schema translator 16 has two functions. The first function is to generate a unique search object (SO) to query one or more of the databases (DB₁-DBₙ) at a Web site. The second function is to generate additional interview questions for a user.

A basic application for the schema translator is to pass input from a user without augmentation. Thus, querying the one or more databases (DB₁-DBₙ) with a search object (SO) defined by a user's identification of a task to be performed. An unaugmented solution set based upon search results from the one or more databases (DB₁-DBₙ) would be returned to a user.

A more extensive application for the schema translator is where a user is interviewed on an iterative basis until a refined solution set is produced. An initial interview would acquire parameters, which would in turn be sent to the schema translator. The schema translator deciphers the acquired parameters (e.g., task identification) and formulates a database search object (SO). The databases (DB₁-DBₙ) are queried with the search object (SO) and a first result (solution) set is returned to the user. The databases (DB₁-DBₙ) also return data to the schema translator to formulate and display additional interview questions for the user. This iterative process continues until the schema translator is satisfied that the refined solution set(s) is/are adequately comprehensive.

### EXAMPLE

In this example a contractor (user) will come to a Web site having the task of “crushing rock” to perform. The user will enter the Task Advisor section of the Web site and select the task “rock crushing”. This request will then go to the schema translator, which will query the database(s) and return a “solution set” to the user's display. In this example the schema translator will display hydraulic, pneumatic hammers, and static rock crushers as “solutions” to the user's task. Simultaneously the schema translator receives and interprets database feedback, and sends additional interview data to the user. Interview questions may include various types of questions including, but not limited to questions related to types of equipment and to performance questions about a task to be performed. Exemplary questions may include: “Do you prefer hydraulic hammers, pneumatic hammers, static rock crushers, or is either acceptable?” and “How many tons of rock do you want to crush per hour?”

In this example the user chooses hydraulic hammers as the preference and selects a performance criterion of two tons of rock per hour. The translator then accepts this preference and at this time only hydraulic hammers are displayed to the user as a solution to the task. The translator then asks the user if he/she would like to search for compatible host machines. In this example the user answers, “Yes”. The schema translator then searches for all host machines compatible with hydraulic hammers. In this example the database returns compatible backhoes and compatible excavators, which are then displayed to the user. Then the schema translator tailors another interview and asks the user, “Do you have any preference to manufacturers of hammers, backhoes, excavators, or no preference?” In this example the user prefers Manufacturer “X's” hammer-A and Manufacturer “Y's” backhoe-B. The schema translator accepts this interview data and searches for compatible work tools for the Manufacturer “Y” backhoe-B. In this example the database returns a broom, multi-purpose & general-purpose bucket, forks, and a clam excavator bucket with a hydraulic thumb. This database feedback is accepted by the schema translator, which in this example determines that there is no additional data in the database that will provide a more complete solution for the user's task.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

We claim:

1. A method of selecting devices to perform a task, comprising:
receiving a task description from a user;
generating a list of devices for performing the task;
determining if additional information is needed from the user to refine the generated list; and
querying the user for more information if additional information is needed from the user to refine the generated list.

2. The method of claim 1, wherein querying the user for more information comprises:
presenting the user with at least one question related to the task description; and
receiving an answer to the at least one question from the user.

3. The method of claim 2, wherein presenting the user with the at least one question comprises:
presenting the user with at least one question relating to a performance criterion for performing the task.

4. The method of claim 2, further comprising:
refining the generated list of devices based on the answer to the at least one question from the user.

5. The method of claim 1, wherein the list of devices comprises a device combination, the method further comprising:
verifying that the devices comprising the device combination are compatible with each other.

6. The method of claim 5, wherein verifying that the devices comprising the device combination are compatible with each other comprises:
verifying that the devices comprising the device combination are compatible with each other based on at least one compatibility criterion selected from the group of compatibility criteria consisting of geometric compatibility, hydraulic compatibility, and capacity compatibility.

7. The method of claim 6, further comprising:
assigning a degree of compatibility to the devices comprising the device combination based on the selected at least one compatibility criterion.

8. The method of claim 1, wherein generating the list of devices for performing the task comprises:
ranking the devices comprising the list of devices based on suitability for performing the task.

9. The method of claim 1, wherein generating the list of devices for performing the task comprises:
forming a database query based on the task description; and
searching at least one database using the database query.

10. The method of claim 9, wherein the at least one database comprises at least one database selected from the group of databases consisting of an online product database, a rental equipment database, an auction equipment database, a new equipment database, and a user equipment database.

11. The method of claim 1, further comprising:
receiving a selection of at least one device from the list of possible devices from the user; and
determining whether the selected at least one device is an attachment device, a dedicated device, or a host device.

12. The method of claim 11, further comprising:
presenting the user with an option of acquiring the selected at least one device if the selected at least one device is a dedicated device;
receiving a response from the user indicating whether the user desires to acquire the selected at least one device; and
acquiring the selected at least one device for the user if the user desires to acquire the selected at least one device.

13. The method of claim 11, further comprising:
presenting the user with an option of searching for at least one host device that is compatible with the selected at least one device if the selected at least one device is an attachment device;
and
receiving a response from the user indicating whether the user desires to search for at least one host device that is compatible with the selected at least one device.

14. The method of claim 13, further comprising:
presenting the user with an option of acquiring the selected at least one device if the user does not desire to search for at least one host device that is compatible with the selected at least one device;
receiving a response from the user indicating whether the user desires to acquire the selected at least one device; and
acquiring the selected at least one selected device for the user if the user desires to acquire the selected at least one device.

15. The method of claim 13, further comprising:
generating a list of at least one host device that is compatible with the selected at least one device if the user desires to search for at least one host device that is compatible with the selected at least one device.

16. The method of claim 15, wherein generating the list of at least one host device that is compatible with the selected at least one device comprises:
forming a database query based on the selected at least one device; and
searching at least one database using the database query.

17. The method of claim 16, wherein the at least one database comprises at least one database selected from the group of databases consisting of an online product database, a rental equipment database, an auction equipment database, a new equipment database, and a user equipment database.

18. The method of claim 15, further comprising:
presenting the user with an option of acquiring the selected at least one device and a host device from the list of at least one host device;
receiving a response from the user indicating whether the user desires to acquire the selected at least one device and the host device from the list of at least one host device; and
acquiring the selected at least one device and the host device from the list of at least one host device for the user if the user desires to acquire the selected at least one device and the host device from the list of at least one host device.

19. The method of claim 18, wherein presenting the user with the option of acquiring the selected at least one device and the host device from the list of at least one host device comprises:
presenting the user with an option of selecting the host device from the list of at least one host device that is compatible with the selected at least one device; and receiving a selection of the host device from the list of at least one host device that is compatible with the selected at least one device from the user.

20. The method of claim 19, wherein acquiring the selected at least one device and the host device from the list of at least one host device for the user comprises:
acquiring the selected at least one device and the selected at least one host device from the list of at least one host device for the user if the user desires to acquire the selected at least one device and the selected at least one host device from the list of at least one host device.

21. The method of claim 11, further comprising:
presenting the user with an option of searching for at least one attachment device that is compatible with the selected at least one device if the selected at least one device is a host device; and
receiving a response from the user indicating whether the user desires to search for at least one attachment device that is compatible with the selected at least one device.

22. The method of claim 21, further comprising:
presenting the user with an option of acquiring the selected at least one device if the user does not desire to search for at least one attachment device that is compatible with the selected at least one device;
receiving a response from the user indicating whether the user desires to acquire the selected at least one device; and
acquiring the selected at least one selected device for the user if the user desires to acquire the selected at least one device.

23. The method of claim 21, further comprising:
generating a list of at least one attachment device that is compatible with the selected at least one device if the user desires to search for at least one attachment device that is compatible with the selected at least one device.

24. The method of claim 23, wherein generating the list of at least one attachment device that is compatible with the selected at least one device comprises:
forming a database query based on the selected at least one device; and
searching at least one database using the database query.

25. The method of claim 24, wherein the at least one database comprises at least one database selected from the group of databases consisting of an online product database, a rental equipment database, an auction equipment database, a new equipment database, and a user equipment database.

26. The method of claim 23, further comprising:
presenting the user with an option of acquiring the selected at least one device and a attachment device from the list of at least one attachment device;
receiving a response from the user indicating whether the user desires to acquire the selected at least one device and the attachment device from the list of at least one attachment device; and
acquiring the selected at least one device and the attachment device from the list of at least one attachment device for the user if the user desires to acquire the selected at least one device and the attachment device from the list of at least one attachment device.

27. The method of claim 26, wherein presenting the user with the option of acquiring the selected at least one device and the attachment device from the list of at least one attachment device comprises:
presenting the user with an option of selecting the attachment device from the list of at least one attachment device that is compatible with the selected at least one device; and
receiving a selection of the attachment device from the list of at least one attachment device that is compatible with the selected at least one device from the user.

28. The method of claim 27, wherein acquiring the selected at least one device and the attachment device from the list of at least one attachment device for the user comprises:
acquiring the selected at least one device and the selected at least one attachment device from the list of at least one attachment device for the user if the user desires to acquire the selected at least one device and the selected at least one attachment device from the list of at least one attachment device.

29. A system for selecting devices to perform a task, comprising:
means for receiving a task description from a user;
means for generating a list of devices for performing the task;
means for determining if additional information is needed from the user to refine the generated list; and
means for querying the user for more information if additional information is needed from the user to refine the generated list.

30. The system of claim 29, wherein the means for querying the user for more information comprises:
means for presenting the user with at least one question related to the task description; and
means for receiving an answer to the at least one question from the user.

31. The system of claim 30, wherein the means for presenting the user with the at least one question comprises:
means for presenting the user with at least one question relating to a performance criterion for performing the task.

32. The system of claim 30, further comprising:
means for refining the generated list of devices based on the answer to the at least one question from the user.

33. The system of claim 29, wherein the list of devices comprises a device combination, the system further comprising:
means for verifying that the devices comprising the device combination are compatible with each other.

34. The system of claim 33, wherein the means for verifying that the devices comprising the device combination are compatible with each other comprises:
means for verifying that the devices comprising the device combination are compatible with each other based on at least one compatibility criterion selected from the group of compatibility criteria consisting of geometric compatibility, hydraulic compatibility, and capacity compatibility.

35. The system of claim 34, further comprising:
means for assigning a degree of compatibility to the devices comprising the device combination based on the selected at least one compatibility criterion.

36. The system of claim 29, wherein the means for generating the list of devices for performing the task comprises:
means for ranking the devices comprising the list of devices based on suitability for performing the task.

37. The system of claim 29, wherein the means for generating the list of devices for performing the task comprises:
means for forming a database query based on the task description; and
means for searching at least one database using the database query.

38. The system of claim 37, wherein the at least one database comprises at least one database selected from the group of databases consisting of an online product database, a rental equipment database, an auction equipment database, a new equipment database, and a user equipment database.

39. The system of claim 29, further comprising:
means for receiving a selection of at least one device from the list of possible devices from the user; and
means for determining whether the selected at least one device is an attachment device, a dedicated device, or a host device.

40. The system of claim 39, further comprising:
means for presenting the user with an option of acquiring the selected at least one device if the selected at least one device is a dedicated device;
means for receiving a response from the user indicating whether the user desires to acquire the selected at least one device; and
means for acquiring the selected at least one device for the user if the user desires to acquire the selected at least one device.

41. The system of claim 39, further comprising:
means for presenting the user with an option of searching for at least one host device that is compatible with the selected at least one device if the selected at least one device is an attachment device;
and
means for receiving a response from the user indicating whether the user desires to search for at least one host device that is compatible with the selected at least one device.

42. The system of claim 41, further comprising:
means for presenting the user with an option of acquiring the selected at least one device if the user does not desire to search for at least one host device that is compatible with the selected at least one device;
means for receiving a response from the user indicating whether the user desires to acquire the selected at least one device; and
means for acquiring the selected at least one selected device for the user if the user desires to acquire the selected at least one device.

43. The system of claim 41, further comprising:
means for generating a list of at least one host device that is compatible with the selected at least one device if the user desires to search for at least one host device that is compatible with the selected at least one device.

44. The system of claim 43, wherein the means for generating the list of at least one host device that is compatible with the selected at least one device comprises:
means for forming a database query based on the selected at least one device; and
means for searching at least one database using the database query.

45. The system of claim 44, wherein the at least one database comprises at least one database selected from the group of databases consisting of an online product database, a rental equipment database, an auction equipment database, a new equipment database, and a user equipment database.

46. The system of claim 43, further comprising:
means for presenting the user with an option of acquiring the selected at least one device and a host device from the list of at least one host device;
means for receiving a response from the user indicating whether the user desires to acquire the selected at least one device and the host device from the list of at least one host device; and
means for acquiring the selected at least one device and the host device from the list of at least one host device for the user if the user desires to acquire the selected at least one device and the host device from the list of at least one host device.

47. The system of claim 46, wherein the means for presenting the user with the option of acquiring the selected at least one device and the host device from the list of at least one host device comprises:
means for presenting the user with an option of selecting the host device from the list of at least one host device that is compatible with the selected at least one device; and
means for receiving a selection of the host device from the list of at least one host device that is compatible with the selected at least one device from the user.

48. The system of claim 47, wherein the means for acquiring the selected at least one device and the host device from the list of at least one host device for the user comprises:
means for acquiring the selected at least one device and the selected at least one host device from the list of at least one host device for the user if the user desires to acquire the selected at least one device and the selected at least one host device from the list of at least one host device.

49. The system of claim 39, further comprising:
means for presenting the user with an option of searching for at least one attachment device that is compatible with the selected at least one device if the selected at least one device is a host device; and
means for receiving a response from the user indicating whether the user desires to search for at least one attachment device that is compatible with the selected at least one device.

50. The system of claim 41, further comprising:
means for presenting the user with an option of acquiring the selected at least one device if the user does not desire to search for at least one attachment device that is compatible with the selected at least one device;
means for receiving a response from the user indicating whether the user desires to acquire the selected at least one device; and
means for acquiring the selected at least one selected device for the user if the user desires to acquire the selected at least one device.

51. The system of claim 41, further comprising:
means for generating a list of at least one attachment device that is compatible with the selected at least one device if the user desires to search for at least one attachment device that is compatible with the selected at least one device.

52. The system of claim 43, wherein the means for generating the list of at least one attachment device that is compatible with the selected at least one device comprises:
means for forming a database query based on the selected at least one device; and
means for searching at least one database using the database query.

53. The system of claim 44, wherein the at least one database comprises at least one database selected from the group of databases consisting of an online product database, a rental equipment database, an auction equipment database, a new equipment database, and a user equipment database.

54. The system of claim 43, further comprising:
means for presenting the user with an option of acquiring the selected at least one device and a attachment device from the list of at least one attachment device;
means for receiving a response from the user indicating whether the user desires to acquire the selected at least one device and the attachment device from the list of at least one attachment device; and
means for acquiring the selected at least one device and the attachment device from the list of at least one attachment device for the user if the user desires to acquire the selected at least one device and the attachment device from the list of at least one attachment device.

55. The system of claim 46, wherein the means for presenting the user with the option of acquiring the selected at least one device and the attachment device from the list of at least one attachment device comprises:
means for presenting the user with an option of selecting the attachment device from the list of at least one attachment device that is compatible with the selected at least one device; and
means for receiving a selection of the attachment device from the list of at least one attachment device that is compatible with the selected at least one device from the user.

56. The system of claim 47, wherein the means for acquiring the selected at least one device and the attachment device from the list of at least one attachment device for the user comprises:
means for acquiring the selected at least one device and the selected at least one attachment device from the list of at least one attachment device for the user if the user desires to acquire the selected at least one device and the selected at least one attachment device from the list of at least one attachment device.

57. A computer program product for selecting devices to perform a task, comprising:
a computer readable program medium having computer readable program code embodied therein, the computer readable program code comprising:
computer readable program code for receiving a task description from a user;
computer readable program code for generating a list of devices for performing the task;
computer readable program code for determining if additional information is needed from the user to refine the generated list; and
computer readable program code for querying the user for more information if additional information is needed from the user to refine the generated list.

58. The computer program product of claim 57, wherein the computer readable program code for querying the user for more information comprises:
computer readable program code for presenting the user with at least one question related to the task description; and computer readable program code for receiving an answer to the at least one question from the user.

59. The computer program product of claim 58, wherein the computer readable program code for presenting the user with the at least one question comprises:
computer readable program code for presenting the user with at least one question relating to a performance criterion for performing the task.

60. The computer program product of claim 58, further comprising:
computer readable program code for refining the generated list of devices based on the answer to the at least one question from the user.

61. The computer program product of claim 57, wherein the list of devices comprises a device combination, the system further comprising:
computer readable program code for verifying that the devices comprising the device combination are compatible with each other.

62. The computer program product of claim 61, wherein the computer readable program code for verifying that the devices comprising the device combination are compatible with each other comprises:
computer readable program code for verifying that the devices comprising the device combination are compatible with each other based on at least one compatibility criterion selected from the group of compatibility criteria consisting of geometric compatibility, hydraulic compatibility, and capacity compatibility.

63. The computer program product of claim 62, further comprising:
computer readable program code for assigning a degree of compatibility to the devices comprising the device combination based on the selected at least one compatibility criterion.

64. The computer program product of claim 57, wherein the computer readable program code for generating the list of devices for performing the task comprises:
computer readable program code for ranking the devices comprising the list of devices based on suitability for performing the task.

65. The computer program product of claim 57, wherein the computer readable program code for generating the list of devices for performing the task comprises:
computer readable program code for forming a database query based on the task description; and
computer readable program code for searching at least one database using the database query.

66. The computer program product of claim 65, wherein the at least one database comprises at least one database selected from the group of databases consisting of an online product database, a rental equipment database, an auction equipment database, a new equipment database, and a user equipment database.

67. The computer program product of Claim 57, further comprising:
computer readable program code for receiving a selection of at least one device from the list of possible devices from the user; and
computer readable program code for determining whether the selected at least one device is an attachment device, a dedicated device, or a host device.

68. The computer program product of claim 67, further comprising:
computer readable program code for presenting the user with an option of acquiring the selected at least one device if the selected at least one device is a dedicated device;
computer readable program code for receiving a response from the user indicating whether the user desires to acquire the selected at least one device;
and
computer readable program code for acquiring the selected at least one device for the user if the user desires to acquire the selected at least one device.

69. The computer program product of claim 67, further comprising:
computer readable program code for presenting the user with an option of searching for at least one host device that is compatible with the selected at least one device if the selected at least one device is an attachment device; and
computer readable program code for receiving a response from the user indicating whether the user desires to search for at least one host device that is compatible with the selected at least one device.

70. The computer program product of claim 69, further comprising:
computer readable program code for presenting the user with an option of acquiring the selected at least one device if the user does not desire to search for at least one host device that is compatible with the selected at least one device;
computer readable program code for receiving a response from the user indicating whether the user desires to acquire the selected at least one device;
and
computer readable program code for acquiring the selected at least one selected device for the user if the user desires to acquire the selected at least one device.

71. The computer program product of claim 69, further comprising:
computer readable program code for generating a list of at least one host device that is compatible with the selected at least one device if the user desires to search for at least one host device that is compatible with the selected at least one device.

72. The computer program product of claim 71, wherein the computer readable program code for generating the list of at least one host device that is compatible with the selected at least one device comprises:
computer readable program code for forming a database query based on the selected at least one device; and computer readable program code for searching at least one database using the database query.

73. The computer program product of claim 72, wherein the at least one database comprises at least one database selected from the group of databases consisting of an online product database, a rental equipment database, an auction equipment database, a new equipment database, and a user equipment database.

74. The computer program product of claim 71, further comprising:
computer readable program code for presenting the user with an option of acquiring the selected at least one device and a host device from the list of at least one host device;
computer readable program code for receiving a response from the user indicating whether the user desires to acquire the selected at least one device and the host device from the list of at least one host device; and
computer readable program code for acquiring the selected at least one device and the host device from the list of at least one host device for the user if the user desires to acquire the selected at least one device and the host device from the list of at least one host device.

75. The computer program product of claim 74, wherein the computer readable program code for presenting the user with the option of acquiring the selected at least one device and the host device from the list of at least one host device comprises:
computer readable program code for presenting the user with an option of selecting the host device from the list of at least one host device that is compatible with the selected at least one device; and
computer readable program code for receiving a selection of the host device from the list of at least one host device that is compatible with the selected at least one device from the user.

76. The computer program product of claim 75, wherein the computer readable program code for acquiring the selected at least one device and the host device from the list of at least one host device for the user comprises:
computer readable program code for acquiring the selected at least one device and the selected at least one host device from the list of at least one host device for the user if the user desires to acquire the selected at least one device and the selected at least one host device from the list of at least one host device.

77. The computer program product of claim 67, further comprising:
computer readable program code for presenting the user with an option of searching for at least one attachment device that is compatible with the selected at least one device if the selected at least one device is a host device; and
computer readable program code for receiving a response from the user indicating whether the user desires to search for at least one attachment device that is compatible with the selected at least one device.

78. The computer program product of claim 69, further comprising:
computer readable program code for presenting the user with an option of acquiring the selected at least one device if the user does not desire to search for at least one attachment device that is compatible with the selected at least one device;
computer readable program code for receiving a response from the user indicating whether the user desires to acquire the selected at least one device;
and
computer readable program code for acquiring the selected at least one selected device for the user if the user desires to acquire the selected at least one device.

79. The computer program product of claim 69, further comprising:
computer readable program code for generating a list of at least one attachment device that is compatible with the selected at least one device if the user desires to search for at least one attachment device that is compatible with the selected at least one device.

80. The computer program product of claim 71, wherein the computer readable program code for generating the list of at least one attachment device that is compatible with the selected at least one device comprises:
computer readable program code for forming a database query based on the selected at least one device; and
computer readable program code for searching at least one database using the database query.

81. The computer program product of claim 72, wherein the at least one database comprises at least one database selected from the group of databases consisting of an online product database, a rental equipment database, an auction equipment database, a new equipment database, and a user equipment database.

82. The computer program product of claim 71, further comprising:
computer readable program code for presenting the user with an option of acquiring the selected at least one device and a attachment device from the list of at least one attachment device;
computer readable program code for receiving a response from the user indicating whether the user desires to acquire the selected at least one device and the attachment device from the list of at least one attachment device; and
computer readable program code for acquiring the selected at least one device and the attachment device from the list of at least one attachment device for the user if the user desires to acquire the selected at least one device and the attachment device from the list of at least one attachment device.

83. The computer program product of claim 74, wherein the computer readable program code for presenting the user with the option of acquiring the selected at least one device and the attachment device from the list of at least one attachment device comprises:
computer readable program code for presenting the user with an option of selecting the attachment device from the list of at least one attachment device that is compatible with the selected at least one device; and
computer readable program code for receiving a selection of the attachment device from the list of at least one attachment device that is compatible with the selected at least one device from the user.

84. The computer program product of claim 75, wherein the computer readable program code for acquiring the selected at least one device and the attachment device from the list of at least one attachment device for the user comprises:
computer readable program code for acquiring the selected at least one device and the selected at least one attachment device from the list of at least one attachment device for the user if the user desires to acquire the selected at least one device and the selected at least one attachment device from the list of at least one attachment device.
